(19) United States
(12) Patent Application Publication
(10) Pub. No.: US 2014/0096985 A1
(43) Pub. Date: Apr. 10, 2014

(54) METHOD AND MECHANISM FOR THE INDIRECT COUPLING TORQUE CONTROL

(71) Applicant: CHINA PNEUMATIC CORPORATION, Chungli (TW)

(72) Inventors: Hsiu-Feng CHU, Chungli (TW); Ming-Zuan TSAI, Chungli (TW)

(73) Assignee: CHINA PNEUMATIC CORPORATION, Chungli (TW)

(21) Appl. No.: 13/785,721

(22) Filed: Mar. 5, 2013

(30) Foreign Application Priority Data
Oct. 5, 2012 (TW) 101137012

(51) Int. Cl. B25B 21/02; B25B 23/14

(52) U.S. Cl. CPC B25B 21/02; B25B 23/1405
USPC 173/1; 173/182

(57) ABSTRACT

A method and mechanism of the indirect coupling torque control provides a rotary impact mechanism driving a rotary drive mechanism linked between the rotary impact mechanism and a fastener member, when the rotary impact mechanism rotates the fastener member. The rotary drive mechanism can accumulate a rotation stress generated by the rotary impact mechanism to rotate the fastener member. When the rotation stress accumulated in the rotary drive mechanism is larger than the torque value applied to the fastener member, a linear relation between a sensed signal measured from the stress accumulated in the rotary drive mechanism and the torque value applied to the fastener member is provided. Whereby the linear relation is used to control the torque valued applied to the fastener member when the rotary impact mechanism is rotating.

### BACKGROUND OF THE INVENTION

1. Field of the Invention

The present invention relates to a power tightening tool and in particular to a power torque tightening tool suitable for a pulse or impact wrench with a rotary impact mechanism, which can be used as a method and mechanism for the indirect coupling torque control when the pulse or impact wrench applies the torque to a fastener member.

2. Description of Related Art

Compared with the hydraulic pulse wrench, servo-electric wrench, or ratchet wrench, the impact wrench can effectively and rapidly transform the input energy, such as pneumatic, hydraulic, or electric current, into the torque of tightening or loosening. In contrast, for the same torque capacity, the impact wrench has the smallest volume. Besides, another advantage of the impact wrench is that because momentary impact is employed, there is no need to use the reaction arm/bar while tightening the fastener member. Thus, it is very convenient to tighten or loosen the nut or bolt. The reason is that the impact wrench uses the means of momentary impact like hammering a nail. It's effortless and the reaction arm is not required during the rotary impact. However, loud noise is a drawback of the traditional impact wrench and a problem more difficult to overcome is that the capture of the sensed signal is limited, in which the traditional impact wrench always can not perform timely accurate torque control while it applies torque to the fastener member.

The so-called timely accurate torque control is to expect that the torque control mechanism can effectively control the torque within a specific range while it applied torque to the fastener member. The quality of torque control depends on control accuracy and consistency. The closed-loop torque control equipped with sensors ensures greater accuracy than the open-loop torque control which controls the magnitude and frequency of the impact pulse merely by pneumatic/hydraulic, flow and time and then predicts the tightening torque at the fastener member end via a look-up table. In other words, the prerequisite for a closed-loop torque control is whether the feedback signals of the sensors can be detected timely. For the progressing torque control tools such as the hydraulic wrench and servo-electric wrench, the feedback torque signals of their sensors are continuous and almost proportional to the applied torques. Such a stable and linear torque signal surely can be used for torque control; thus, it has been widely used in the manufacturing process of accurate torque control. However, only the torque control of the impact wrench has not been developed. For decades, domestic and foreign companies have devoted themselves to the development of torque control of impact power wrenches, but trapped in theoretical discussion and ideas. So far, there has been no practical and feasible closed-loop real-time torque control mechanism introduced successfully to be used to control the torque of impact power wrenches in the market. This means a considerable difficulty in technique still exists in this field.

As the above description, due to the limitation of capturing the sensed signal, the torque-sensing device such as a torque meter or strain gauge installed in the front of the impact power wrench can only sense the momentary pulse of impact, not able to timely reflect the tightening torque at the fastener member end. In other words, the magnitude (vibration scale) and number (vibration frequency) of the pulses caused by impacts represent the momentary energy transmitted to the drive shaft of the impact power wrench. Though the energy magnitude shows the positive correlation with the tightening torque at the fastener member end, the former is not equal to the latter. The experiment data shows there is no direct relation between the tightening torque accumulated at the fastener member end and the magnitude and frequency of the impact pulses. As shown in FIG. 1, the feedback pulse signals of the sensor are difficult to be used as a reference value of torque control, which is the main reason why it was difficult for the impact power wrench to perform the torque control. That is, when the torque sensor is impacted, the signal generated is neither stable nor linear, but an intermittent pulse signal.

The operation of the traditional impact power tools is carried out as follows. A motor drives a rotary impact mechanism to transform rotary kinetic energy into pulse impact which is transmitted to the fastener member by means of a drive shaft to overcome the static friction and further fixes the fastener member. This kind of torque transmission belongs to transmission of direct coupling and the deformation of the drive shaft under the impact is intermittent. If a sensing element is attached on the drive shaft, the sensed signal will be a series of pulses. Individual pulse signal can not timely reflect the tightening torque at the fastener member end, so the impact power wrench is not able to perform timely, effective, and accurate torque control on the fastener member.

In view of this, the inventor pays special attention to research with the application of related theory and tries to overcome the above disadvantages regarding the above related art. Finally, the inventor proposes a reasonable design and an effective improvement to the above disadvantages, the present invention.

### SUMMARY OF THE INVENTION

The primary objective of the present invention is to provide a method and mechanism for the indirect coupling torque control, which transform the type of torque transmission from direct coupling into indirect coupling by means of a rotary drive mechanism. The rotary kinetic energy generated during the impact is not transmitted directly to the drive shaft, but rather the pulsed impact energy is used to apply a clamping force or stretching tension to a sensing member through a rotary drive mechanism until the static friction at the fastener member end is overcome and a liner signal can be measured through the sensing member. The type of the indirect coupling is that both of the stress accumulated in the rotary drive mechanism and the torque at the fastener member end timely achieve dynamic balance; thus, the torque at the fastener member end can be measured by the linear signal sensed from the sensing member.

To achieve the above objective, the present invention provides a method for the indirect coupling torque control, including the steps of:
a) providing a rotary impact mechanism driving a fastener member to rotate;
b) using a rotary drive mechanism linked between the rotary impact mechanism and the fastener member, the rotary drive mechanism accumulating a rotation stress generated by the rotary impact mechanism to rotate the fastener member; and
c) providing a linear relation between a sensed signal measured from the rotation stress accumulated in the rotary drive mechanism and a torque value applied to the fastener member when the rotation stress accumulated in the rotary drive mechanism is larger than the torque value applied to rotate the fastener member;

whereby the linear relation is used to control the torque value applied to the fastener member when the rotary impact mechanism is rotating.

To achieve the above objective, the present invention provides a mechanism for the indirect coupling torque control which is used to link a rotary impact mechanism to rotate a fastener member, including:

a threaded sleeve driven by the rotary impact mechanism;

a transmission screw screwed by the threaded sleeve to drive a rear drive shaft, whereby to drive the fastener member;

a stress member driven by the threaded sleeve to move axially on the threaded sleeve; and

a sensing member disposed on the transmission screw and disposed axially with respect to

the stress member to withstand compression or tension caused by the stress member,

wherein the thread sleeve has a right-hand thread and a left-hand thread disposed between the transmission screw and the stress member, whereby the rotary impact mechanism drives the threaded sleeve and moves the stress member to compress or stretch the sensing member and thus to measure the sensed signal of the sensing member to obtain an output torque value for torque control.

### BRIEF DESCRIPTION OF DRAWING

FIG. 1 is a diagram of pulse signals generated by the impact mechanism of an impact power wrench of the related art;

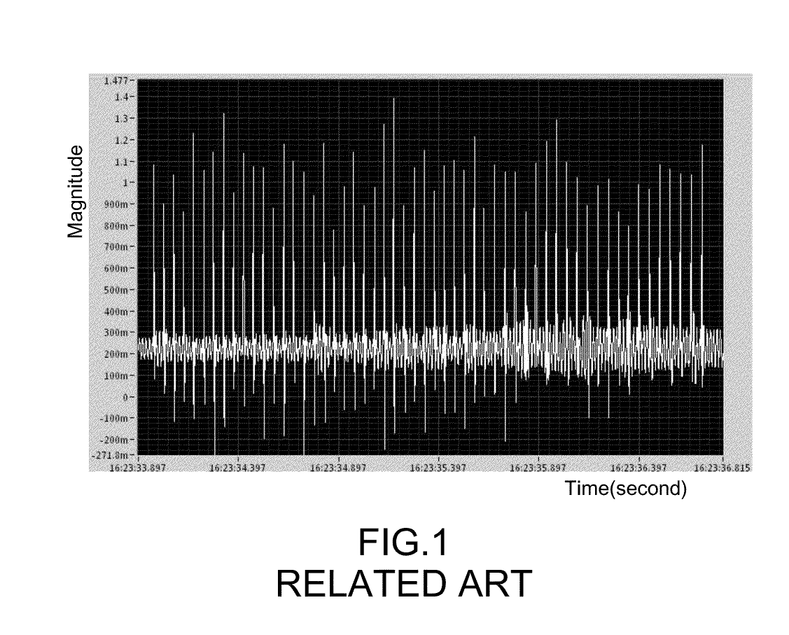

FIG. 2 is an exploded view of the torque control mechanism according to the first embodiment of the present invention;

FIG. 3 is a cross-sectional view of the torque control mechanism according to the first embodiment of the present invention;

FIG. 4 is a cross-sectional view along line 4-4 in FIG. 3;

FIG. 5 is a diagram showing a linear relation, as an example, between the voltage values and the torque values, in which the voltage values can be measured from the sensing member of the torque control mechanism of the present invention; and

FIG. 6 is a cross-sectional view of the torque control mechanism according to the second embodiment of the present invention.

### DETAILED DESCRIPTION OF THE INVENTION

To let the examiner further understand the features and technique of the present invention, please refer to the following detailed description and accompanying figures associated with the present invention. However, the accompanying figures are only for reference and explanation, not to limit the scope of the present invention.

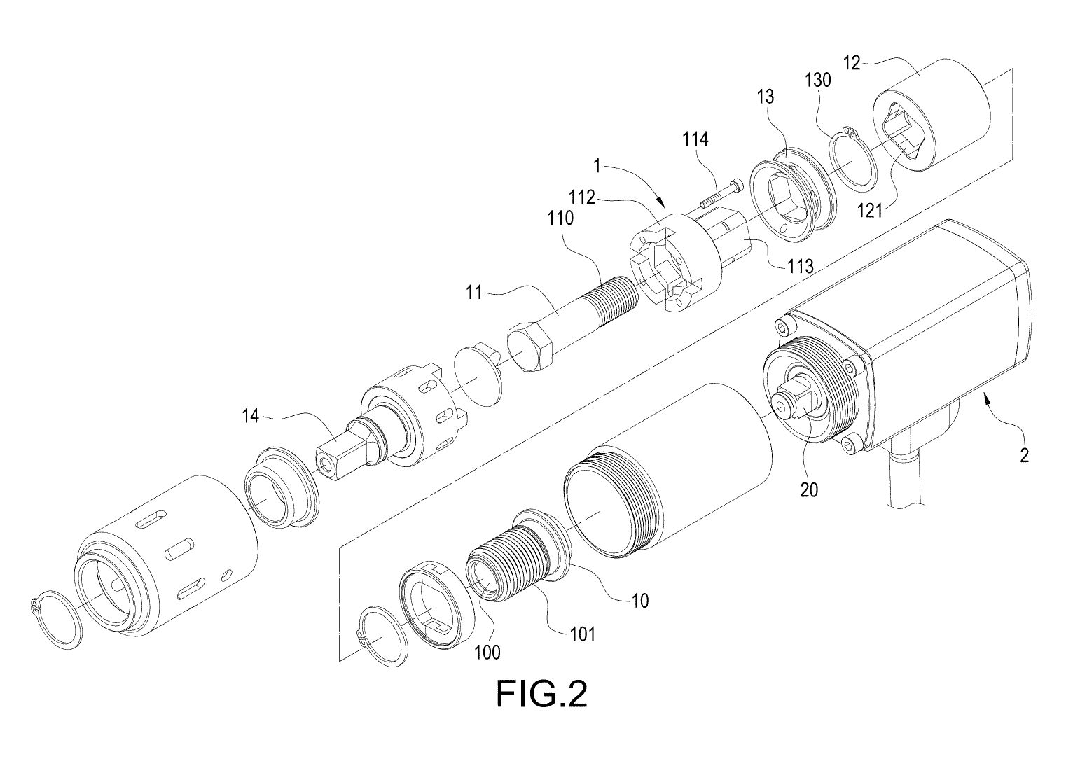

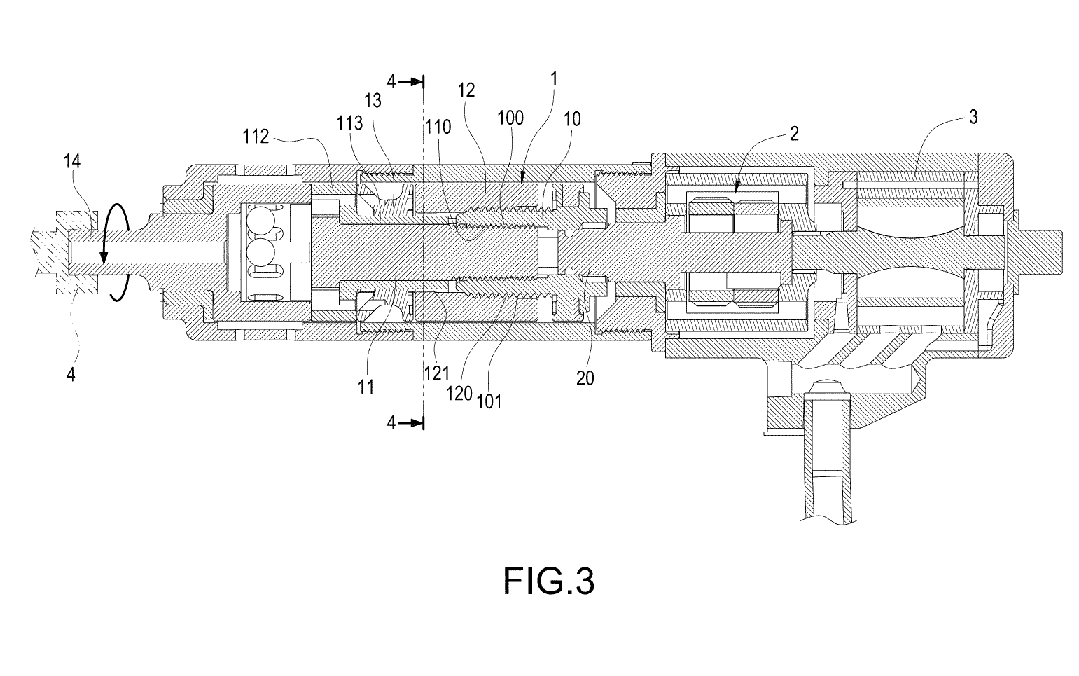

Please refer to FIGS. 2 and 3 which are the exploded view and cross-sectional view of the torque control mechanism according to the first embodiment of the present invention, respectively. The present invention provides a method and mechanism for the indirect coupling torque control. The torque control mechanism 1 is a rotary drive mechanism which is used to link a rotary impact mechanism 2. The rotary impact mechanism 2 is driven by a motor 3 (as shown in FIG. 3) to further drive a front drive shaft 20 to rotate. Since the above-mentioned portion is the basic structure of a traditional impact power wrench, no description is given again here. The torque control mechanism 1 includes a threaded sleeve 10, a transmission screw 11, a stress member 12, and a sensing member 13.

The threaded sleeve 10 transmits power through the front drive shaft 20 of the rotary impact mechanism 2. In the embodiment of the present invention, the torque control mechanism 1 can be retrofitted to a traditional impact power tool by plug-in (however the traditional impact power tool does not have a built-in controller and it needs to combine with an external controller to work), so the threaded sleeve 10 is sleeved around and connected to the front drive shaft 20 for the front drive shaft 20 to transmit the rotary power generated by the rotary impact mechanism 2 to the threaded sleeve 10. Of course, the threaded sleeve 10 also can be directly driven by the rotary impact mechanism 2; that is, the torque control mechanism 1 also can be directly built in the impact power tool.

The transmission screw 11 is screwed together with the threaded sleeve 10 for the rotary impact mechanism 2 to drive the threaded sleeve 10 to rotate on the transmission screw 11. In the embodiment of the present invention, an internal thread 100 is disposed on the inner surface of the threaded sleeve 10 and an external thread 110 is disposed on the outer surface of the front end of the transmission screw 11; thus, the threaded sleeve 10 can be screwed at the front end of the transmission screw 11 and both of them can move back and forth helically.

The stress member 12 is also screwed together with the threaded sleeve 10 so that the threaded sleeve 10 can drive the stress member 12 to move axially when the rotary impact mechanism 2 drives the threaded sleeve 10. In the embodiment of the present invention, the stress member 12 is sleeved around the threaded sleeve 10, an external thread 101 is disposed on the outer surface of the threaded sleeve 10, and an internal thread 120 (as shown in FIG. 3) is disposed on the inner surface of the stress member 12 so that the stress member 12 can be screwed together with the threaded sleeve 10 and, further, when the treaded sleeve 10 is screwed tightly with the transmission screw 11, the sensing member 13 is compressed or stretched along the end portion 113 of the bushing 112 and when the threaded sleeve 10 is screwed out from the transmission screw 11, and the stress member 12 is loosened along the end portion 113 of the bushing 112 away from the sensing member 13 to zero the sensed signal and then complete the reset for the next tightening action.

More broadly, the threaded sleeve 10 has a right-hand thread and a left-hand thread disposed between the transmission screw 11 and the stress member 12. In the embodiment of the present invention, if the positive rotation of the motor 3 is defined as tightening action, the threaded sleeve 10 is screwed together with the transmission screw 11 by means of the right-hand thread and is screwed together with the stress member 12 by means of the left-hand thread and vice versa. When the rotary impact mechanism 2 drives the threaded sleeve 10, the threaded sleeve 10, on one hand, can be screwed tightly to the transmission screw 11 and on the other hand the stress member 12 can be pushed toward the sensing member 13, in which the sensing member 13 is disposed axially with respect to the stress member 12. Also, please refer to FIGS. 2-4. In the embodiment of the present invention, the transmission screw 11 passes through the bushing 112 so that the bushing 112 is sleeved around the transmission screw 11 and the external thread 110 of the transmission screw 11 protrudes from one end of the bushing 112. One end of the bushing 112 has an end portion 113 around which the sensing member 13 is sleeved; a retainer 130 is used to position the sensing member 13 which withstands the force applied when the stress member 12 approaches to the retainer 130. The sensing member 13 is a load cell or a strain gauge in the embodiment. When a strain gauge is used as the sensing member 13 and disposed axially with respect to the transmission screw 11, both of the strain gauge and the transmission screw 11 form a sensing bolt with a strain-sensing function. The sensing bolt can take the place of the load cell to detect the sensed signal corresponding to the output torque at the rear drive shaft 14 end.

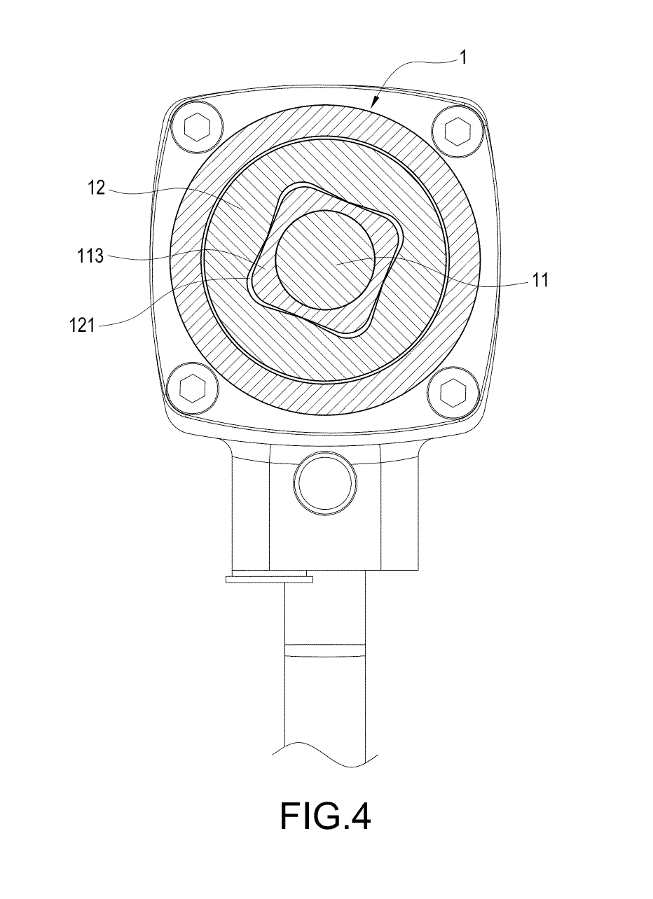

As shown in FIGS. 3 and 4, part of the end portion 113 protrudes out of the sensing member 13 and the cross-section of the end portion 113 has a shape of a polygon (a semi-quadrilateral in the embodiment). The stress member 12 has a fitting engaging hole 121 sleeved moveably with respect to the end portion 113. When the internal thread 120 of the stress member 12 is screwed into the external thread 101 of the threaded sleeve 10, due to the fitting between the engaging hole 121 of the stress member 12 and the end portion 113 being polygon, the stress member 12 can move only along the axis of the end portion 113 and can not produce a rotation movement with respect to the end portion 113. Therefore, the threaded sleeve 10 will also drive the stress member 12 to axially move toward or away from the sensing member 13. The stress member 12, sensing member 13, and the bushing 112 can be connected moveably by a guide pin so that the stress member 12 and the sensing member 13 can axially move only along the end portion 113 of the bushing 112 and can not produce a rotation movement with respect to the end portion 13. Moreover, after the threaded sleeve 10 is screwed tightly together with the transmission screw 11, the transmission screw 11 drives the rear drive shaft 14 at the end of the torque control mechanism 1. Through the rotation of the rear drive shaft 14, the fastener member 4 (such as a socket, bolt or a nut) can be tightened or loosened. In the present invention, the bolts 114 are used to fasten the bushing 112 to the rear drive shaft 14 so that the rear drive shaft 14 can be linked with the transmission screw 11.

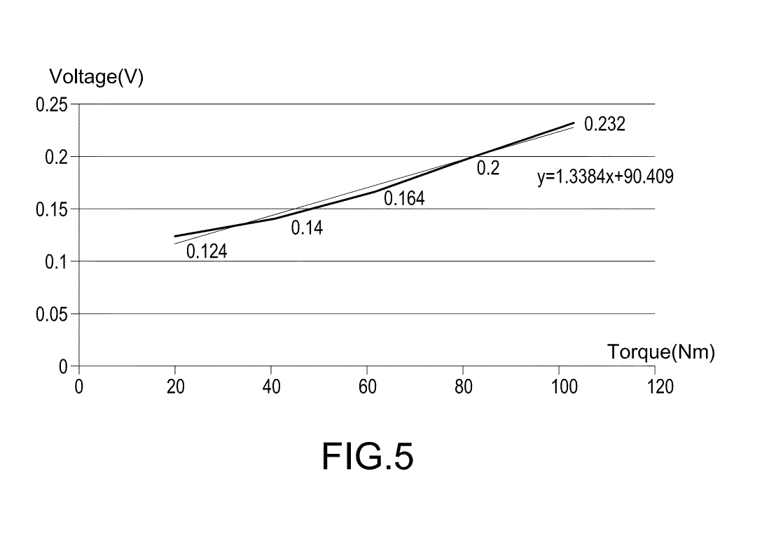

With the above description in mind, the torque control mechanism 1 is linked between the rotary impact mechanism 2 and the fastener member 4; thus, the rotary impact mechanism 2 can drive the torque control mechanism 1 by means of the power of the motor 3 and further rotate the fastener member 4. During the rotation of the rotary impact mechanism 2, the threaded sleeve 10 is forced to push the stress member 12 to move toward the sensing member 13 so that the torque control mechanism 1 can accumulate the rotation stress generated by the rotary impact mechanism 2. When the rotation stress accumulated in the torque control mechanism 1 is larger than the torque value applied to rotate the fastener member 4, the static friction at the fastener member 4 can be overcome and the fastener member 4 is fastened more tightly. At this moment, the torque between the threaded sleeve 10 and the font drive shaft 20 is equal to (or extremely equal to) the torque applied at the fastener member 4 end, so the direct clamping force or stretching tension can be measured by the sensing member 13 by means of the continuous compression or tension of the sensing member 13 caused by the stress member 12. In this way, a liner relation (as shown in FIG. 5) between the voltage value (i.e., the sensed signal) of the rotation stress accumulated in the torque control mechanism 1 and the torque value applied to the fastener member 4 can be obtained. Therefore, the linear relation can be used to control the torque value applied to the fastener member 4 when the rotary impact mechanism 2 is rotating to achieve the objective of the present invention.

Accordingly, based on the above structure composition and theory thereof, the method and mechanism for the indirect coupling torque control of the present invention is obtained.

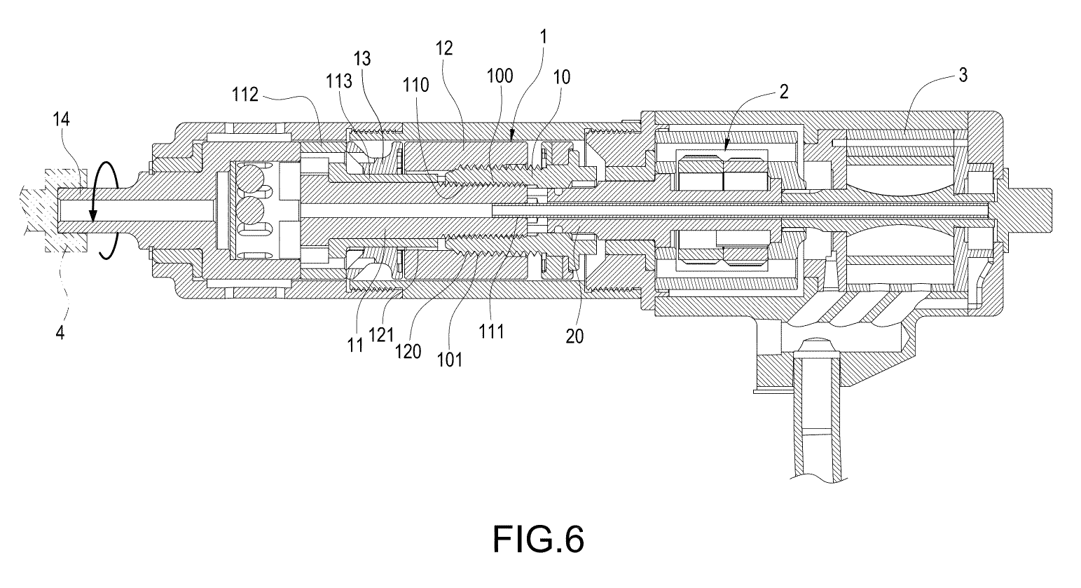

It is worthy to mention that, in the first embodiment of the present invention in FIG. 3, the sensing member 13 transmits the sensed signal to a control unit (not shown) for calculation by means of wireless communication (for example RF). Alternatively, in the second embodiment of the present invention in FIG. 6, the sensing member 13 is connected to the above-mentioned control unit by means of wired communication. This can be done by making the transmission screw 11 hollow and placing a guide tube 111 therein through the threaded sleeve 10, the rotary impact mechanism 2, and the motor 3 to provide a passage for the signal wire to connect the above-mentioned control unit.

In summary, the present invention can achieve the expected objective and overcome the disadvantages of the related art; therefore, the present invention is novel and non-obvious. Please examine the application carefully and grant it a patent for protecting the rights of the inventor.

The above description is only the preferred embodiments of the present invention and it will be understood that the above embodiments are not to limit the scope of the present invention. Other equivalent variations and equivalent modifications according to the spirit of the present invention are also embraced within the scope of the present invention as defined in the appended claims.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A method for the indirect coupling torque control, including the steps of:
a) providing a rotary impact mechanism (2) driving a fastener member (4) to rotate;
b) using a rotary drive mechanism linked between the rotary impact mechanism (2) and the fastener member (4), the rotary drive mechanism accumulating a rotation stress generated by the rotary impact mechanism (2) to rotate the fastener member (4); and
c) providing a linear relation between a sensed signal measured from the rotation stress accumulated in the rotary drive mechanism and a torque value applied to the fastener member (4) when the rotation stress accumulated in the rotary drive mechanism is larger than the torque value applied to rotate the fastener member (4),
whereby the linear relation is used to control the torque value applied to the fastener member (4) when the rotary impact mechanism (2) is rotating.

2. The method for the indirect coupling torque control according to claim 1, wherein a sensing member (13) is used in step c) to withstand the rotation stress accumulated in the rotary drive mechanism to measure the sensed signal generated by direct clamping force or stretching tension in the sensing member (13) to obtain the linear relation.

3. The method for the indirect coupling torque control according to claim 2, wherein the sensing member (13) is a load cell.

4. The method for the indirect coupling torque control according to claim 1, wherein the sensed signal is a voltage value.

5. A mechanism for the indirect coupling torque control which is used to link a rotary impact mechanism (2) to drive a fastener member (4), including:
a threaded sleeve (10) driven by the rotary impact mechanism (2);
a transmission screw (11) screwed by the threaded sleeve (10) to drive a rear drive shaft (14), whereby to drive the fastener member (4);
a stress member (12) driven by the threaded sleeve (10) to move axially on the threaded sleeve (10); and
a sensing member (13) disposed on the transmission screw (11) and disposed axially with respect to the stress member (12) to withstand compression or tension caused by the stress member (12),
wherein the thread sleeve (10) has a right-hand thread and a left-hand thread disposed between the transmission screw (11) and the stress member (12), whereby the rotary impact mechanism (2) drives the threaded sleeve (10) and moves the stress member (12) to compress or stretch the sensing member (13) and thus to measure the sensed signal of the sensing member (13) to obtain an output torque value for torque control.

6. The mechanism for the indirect coupling torque control according to claim 5, wherein the threaded sleeve (10) is screwed together with the transmission screw (11) by means of the right-hand thread and the threaded sleeve (10) is screwed with the stress member (12) by means of the left-hand thread.

7. The mechanism for the indirect coupling torque control according to claim 5, wherein the sensing member (13) has wired or wireless signal communication with a control unit.

8. The mechanism for the indirect coupling torque control according to claim 5, wherein the transmission screw (11) further has a bushing (112) sleeved around thereon, one end of the bushing (112) having an end portion (113), the cross-section of the end portion (113) having a shape of a polygon, and the stress member (12) has an engaging hole (121) fitted with the end portion (113), the engaging hole (121) sleeved moveably with respect to the end portion (113).

9. The mechanism for the indirect coupling torque control according to claim 5, wherein the transmission screw (11) further has a bushing (112) sleeved around thereon; the stress member (12), the sensing member (13), and the bushing (112) are connected movably by a guide pin.

10. The mechanism for the indirect coupling torque control according to claim 5, wherein the sensing member (13) is a load cell or a strain gauge which forms a sensing bolt with the transmission screw (11).
